(19) United States
(12) Patent Application Publication
(10) Pub. No.: US 2011/0007423 A1
(43) Pub. Date: Jan. 13, 2011

(54) Supplemental Layer to Reduce Damage from Recording Head to Recording Media Contact

(75) Inventors: Ying Dong, Eden Prairie, MN (US); Gregory M. McMahon, St. Paul, MN (US); Jianxin Zhu, Eagan, MN (US); Steve D. Gartner, Bloomington, MN (US); The Nguyen, Lakeville, MN (US); Lin Zhou, Eagan, MN (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: SEAGATE TECHNOLOGY LLC, Scotts Valley, CA (US)

(21) Appl. No.: 12/501,977

(22) Filed: Jul. 13, 2009

(51) Int. Cl. G11B 5/60; G11B 5/187

(52) U.S. Cl. 360/235.7; 360/122; G9B/5.229

(57) ABSTRACT

Recording heads for data storage systems are provided. Recording heads include a substrate layer made of a first material. The substrate layer has a bearing surface side. A tapered feature made of a second material is included on the bearing surface side. The first material is illustratively a multiphase material and the second material is illustratively diamond-like carbon.

### BACKGROUND

Data storage systems commonly include one or more recording heads that read and write information to a recording medium. It is often desirable to have a relatively small distance or spacing between a recording head and its associated medium. This distance or spacing is known as “fly height” or “head media spacing.” By reducing the head media spacing, a recording head is commonly better able to both read and write to a medium. For example, in the case of magnetic recording, the strength of a recording head magnetic field on a magnetic disc is increased as the head media spacing is decreased. This allows for a stronger (i.e. more easily read) magnetization pattern to be written to the recording disc.

Despite advantages associated with reduced head media spacings, there are also disadvantages. Reduced head media spacings may increase the likelihood or frequency of a recording head making unintended physical contact with a medium. This contact can cause data stored on a medium to be lost and/or cause permanent damage to a medium making it unusable. The contact could similarly generate particulate contamination that could further damage the storage system for example by scratching a medium.

Previous efforts to reduce damage caused by recording head to recording medium contact identified the sharp or pointed corners of recording heads as a factor in increasing the damage. As a result, some recording heads have been made using a milling or etching step to remove the sharp or pointed corners. Although the removal of the recording head sharp corners has reduced the damage, there continues to be damage from recording head to recording media contact.

### SUMMARY

Recording heads for data storage systems are provided. Recording heads include a substrate layer made of a first material. The substrate layer has a bearing surface side. A tapered feature made of a second material is included on the bearing surface side. The first material is illustratively a multiphase material and the second material is illustratively diamond-like carbon.

### BRIEF DESCRIPTION OF THE DRAWINGS

FIG. 1A is a perspective view of a tapered feature made from a supplemental layer.

FIG. 1B is a top down view of a tapered feature made from a supplemental layer.

FIG. 1C is a cross-section of a tapered feature made from a supplemental layer.

FIG. 2 is a perspective view of a hard disc drive.

FIG. 3 is a plan view of a recording head from the air bearing surface side.

FIGS. 4A, 4B, 4C, and 4D are cross-sections of a recording head with a tapered feature.

FIG. 5 is a flow diagram of a process flow for manufacturing a tapered feature.

FIGS. 6A, 6B, 6C, 6D, 6E, 6F, 6G, 6H, and 6I are cross-sections of a recording head throughout a process flow.

FIG. 7 is a representation of the surface of a multiphase material.

FIG. 8 is a graph of the amount of reflected light as a function of the thickness of a supplemental layer.

### DETAILED DESCRIPTION

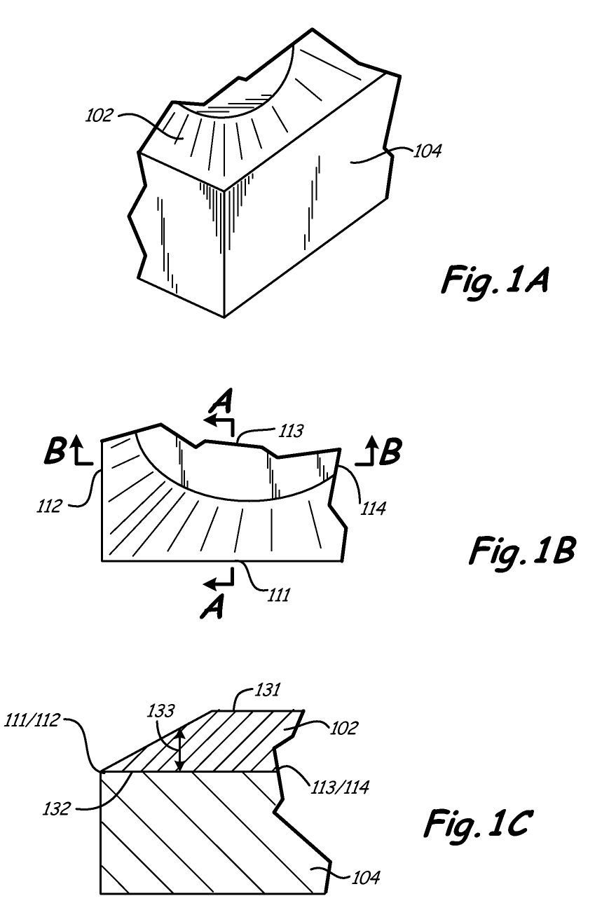

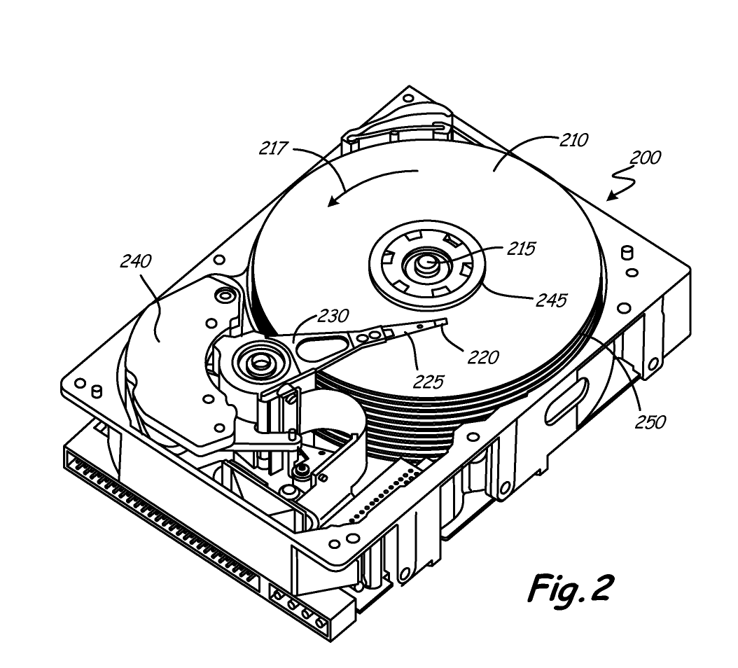

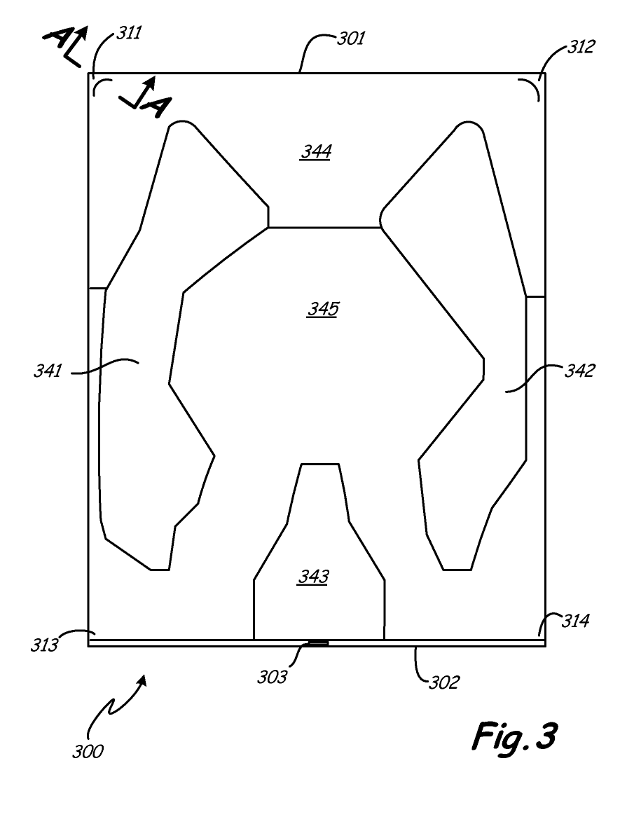

FIG. 1A is a perspective view of one embodiment of a recording head corner that includes a tapered feature 102. FIG. 1B is a top down view of the recording head corner, and FIG. 1C is an illustrative cross-section at line A-A and/or line B-B in FIG. 1B. Tapered feature 102 is illustratively made of a supplemental layer that is placed on the recording head substrate material 104. As was described in the background section, previous efforts to reduce damage caused by recording head to recording head media contact have included tapering the substrate material. Feature 102 illustratively replaces a tapered substrate corner.

FIG. 1B shows that tapered feature 102 includes a first side 111, a second side 112, a third side 113, and a fourth side 114. FIG. 1C shows that tapered feature 102 includes a top side or surface 131, a bottom side or surface 132, and a thickness 133 between top side 131 and bottom side 132. As can be seen in the figures, the thickness 133 of the tapered feature increases going from first side 111 to third side 113, and also increases going from second side 112 to fourth side 114.

As will be described later in greater detail, utilizing a supplemental layer to form a tapered feature provides many advantages. It is however worth noting at this time at least a couple of the advantages. Recording head substrates such as substrate 104 are commonly made from relatively rigid or unforgiving materials. This is done in part because the substrate provides the mechanical or physical support needed to carry and accurately position the reading and writing components of the recording head. The substrate also needs to be capable of providing and withstanding forces associated with the air bearing surface that is needed to position a recording head at the correct head media spacing. Because the choice of substrate material is limited at least in part by other design considerations, the substrate material is not necessarily the best material to reduce damage from recording head to recording medium contact. In accordance with one embodiment of the present disclosure, a supplemental layer is used that causes less damage when contact is made with the recording medium.

Besides the substrate material not necessarily being the best material for contact with the recording medium, the substrate is also not necessarily the best material to be used with processes to taper a corner. For example, in one embodiment, a photolithography process is used in tapering a corner. Photolithography processes utilize light to pattern photoresist. Substrates are commonly made from multiphase materials. Each phase often has a different reflectivity property or characteristic. As will described later, this causes or can cause undesirable non-uniformities in photoresist. These non-uniformities in the photoresist are then transferred to the substrate resulting in increased surface roughness. This surface roughness can increase damage from recording head to recording medium contact. The use of a supplemental layer illustratively reduces these non-uniformities and consequently reduces surface roughness.

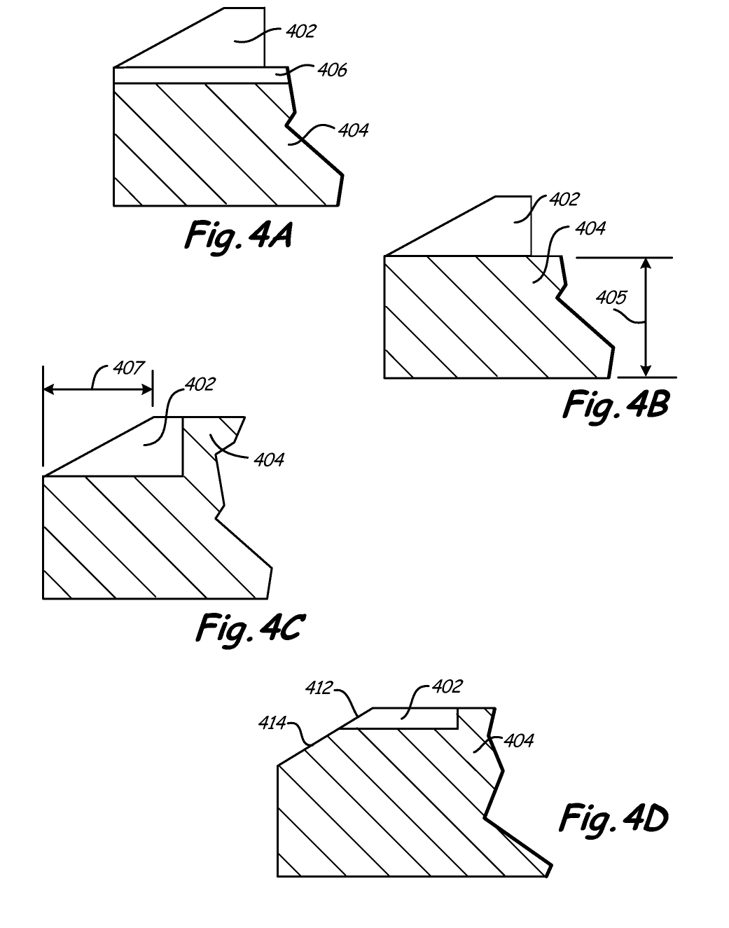

Before discussing embodiments of the present disclosure, it is worthwhile to first describe an illustrative operating environment in which some embodiments may be incorporated. FIG. 2 is a perspective view of a hard disc drive 200. Drive 200 is an example of a device in which some embodiments of the present disclosure may be incorporated. Hard disc drives are a common type of data storage system. While embodiments of this disclosure are described in terms of disc drives, other types of data storage systems should be considered within the scope of the present disclosure.

Disc drive 200 includes a magnetic disc or recording medium 210. Those skilled in the art will recognize that disc drive 200 can contain a single disc or multiple discs. Medium 210 is mounted on a spindle motor assembly 215 that facilitates rotation of the medium about a central axis. An illustrative direction of rotation is shown by arrow 217. Each disc surface has an associated recording head 220 that carries a read/write component for communication with the surface of the disc. Each head 220 is supported by a head gimbal assembly 225, which is in turn attached to an actuator arm 230. Each actuator arm 230 is rotated about a shaft by a voice coil motor assembly 240. As voice coil motor assembly 240 rotates actuator arm 230, head 220 moves in an arcuate path between a disc inner diameter 245 and a disc outer diameter 250.

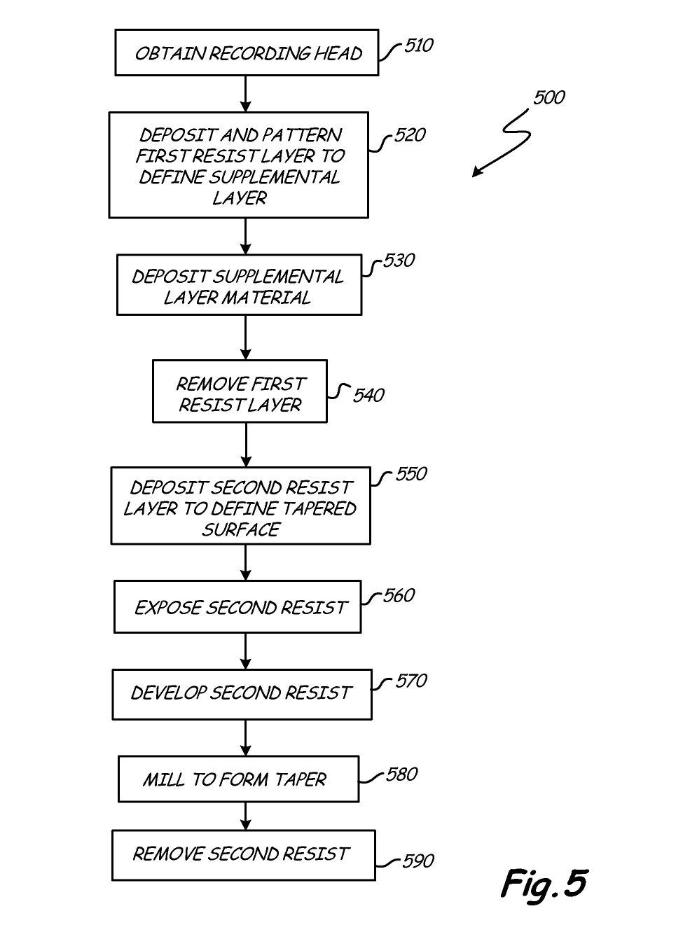

FIG. 3 is a plan view of a recording head 300 from the air bearing surface side. Recording head 300 is illustratively a recording head such as head 220 in FIG. 1 and is illustratively used in a data storage device such as device 200 in FIG. 1. The air bearing surface side of a recording head faces a recording medium such as medium 210 in FIG. 2. Head 300 includes a leading edge or side 301 and a trailing edge or side 302. Recording head 300 is positioned relative to a recording medium such that a particular location on the medium first passes underneath leading edge 301 and then passes underneath trailing edge 302. Recording head 300 also include read/write component 303. Component 303 is shown in FIG. 3 as being at or approximately at the center of trailing edge 302. Component 303 is optionally placed or positioned at any location along trailing edge 302.

As was discussed in the background section, a recording head may unintentionally make physical contact with a recording medium during operation. For example, changes in elevation or environmental vibrations may cause a recording head to contact a recording medium. Also for example, in one embodiment, a ramp load/unload process is used in transitioning a recording head to and from a recording medium. In such a case, instability of the recording head as it transitions either onto or off from the recording medium may cause the recording head to contact a recording medium.

FIG. 3 shows that the air bearing surface side of recording head 300 includes four corner regions. A leading edge left corner region 311, a leading edge right corner region 312, a trailing edge left corner region 313, and a trailing edge right corner region 314. During operation, any of these four regions may contact the recording medium. In FIG. 3, leading edge corner regions 311 and 312 are each shown as including a tapered feature or structure that is made at least in part from a supplemental layer such as tapered feature 102 in FIG. 1A. In another embodiment, tapered features made at least in part from a supplemental layer are included in any one or more of regions 311-314 (e.g. all four corner regions, both trailing edge corner regions, etc.). The inclusion of a tapered feature eliminates or reduces damage or other harmful effects caused by recording head to recording medium contact. Additionally, tapered features are optionally placed at regions of the recording head other than at the corner regions. In an embodiment, tapered features are placed anywhere on the recording head that may contact the recording medium to reduce or eliminate damage from contact. It should also be noted that tapered features are not limited to any particular recording head such as the specific recording head shown in FIG. 3. Embodiments of tapered features are included in all types and configurations of recording heads.

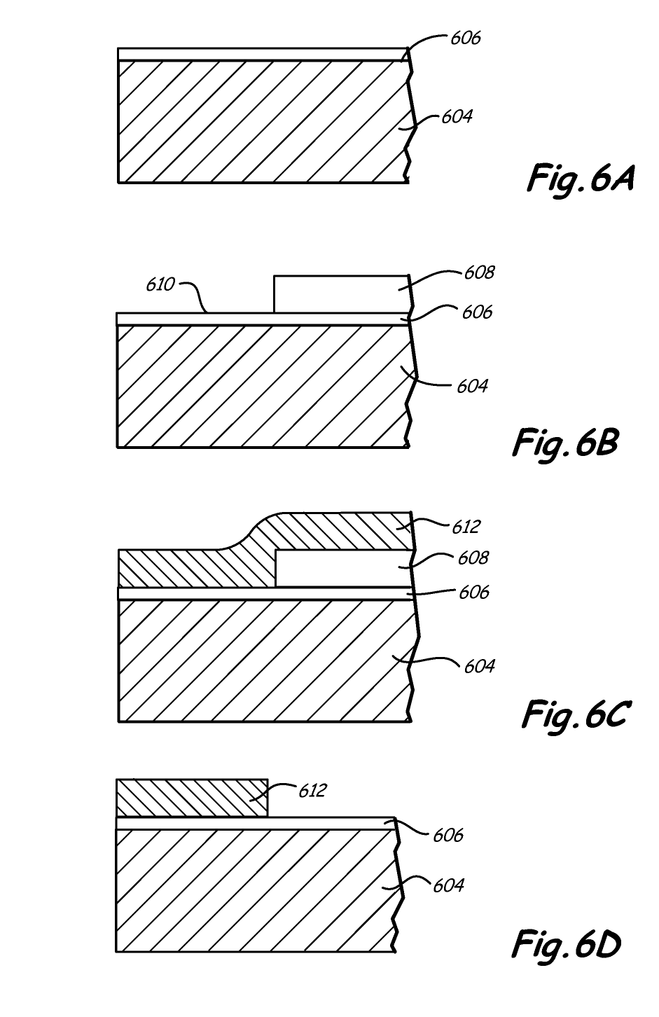

FIG. 3 includes a cross-section line A-A through leading edge left corner region 311. As was previously mentioned, region 311 illustratively includes a tapered feature or structure that is made at least in part from a supplemental layer. FIGS. 4A, 4B, 4C, and 4D each shows an embodiment of an illustrative tapered feature or structure from the perspective of cross-section A-A. As is shown in the figures, embodiments of tapered features or structures are placed or positioned upon any type or variety of underlying layers that are included in a recording head. Additionally, the figures show that in certain embodiments that tapered features or structures extend outward from the air bearing surface, and that in certain other embodiments that tapered features or structures are recessed within a plane of an air bearing surface.

The illustrative cross-section in FIG. 4A shows a recording head substrate 404 that has an overcoat layer 406 on top of it (i.e. on the recording head air bearing surface side). Overcoat layers are commonly applied to recording heads. Overcoat layers are used to prevent corrosion of metal parts of the recording head such as the read/write component. Overcoat layers are also used to prevent substrate wear and/or improve static friction, “stiction,” between a recording head and a recording medium. Overcoats are commonly a relatively thin layer (e.g. 20-30 Angstroms) as compared to the substrate and, as will be discussed later, compared to supplemental layers that form tapered features. FIG. 4A shows that a tapered feature or structure 402 made from a supplemental layer is illustratively placed over or on top of overcoat layer 406. It is worth noting that in an embodiment, such as that shown in FIG. 4A, that feature 402 is added to a recording head with an overcoat layer while leaving the overcoat layer intact (i.e. the overcoat layer is not removed or patterned). Alternatively, in another embodiment, an overcoat layer is patterned such that it forms a tapered surface in cooperation with feature 402.

The illustrative cross-section in FIG. 4B shows a tapered feature 402 placed directly on a recording head substrate 404 (i.e. there is not an intermediary layer such as an overcoat layer separating the substrate from the tapered feature). FIG. 4B also includes a height or thickness 405 that represents the thickness of substrate 404 where feature 402 is located. Recording heads commonly have varying substrate thicknesses. For example, recording head 300 in FIG. 3 includes a first side rail 341, a second side rail 342, a center rail 343, a step 344, and a cavity 345. Rails 341-343 illustratively have a substrate thickness that is greater than step 344, and step 344 has a thickness that is greater than cavity 345. In an embodiment, the thickness 405 of the underlying substrate has any absolute or relative value. For example, feature 402 is illustratively positioned at a substrate location that has a relatively greater or lesser thickness than surrounding areas of the substrate.

The illustrative cross-section in FIG. 4C shows a tapered feature 402 placed in a recessed area of substrate 404. In an embodiment, the substrate beneath feature 402 initially had the same thickness as the substrate proximate feature 402 (i.e. the substrate material to the right of feature 402 in the figure). However, some of the substrate beneath feature 402 is removed prior to forming the feature. In one such embodiment, such as that shown in FIG. 4C, feature 402 fits within the recessed area such that feature 402 does not extend above areas proximate feature 402 or illustratively even extend above any area of the recording head surface.

FIG. 4C also includes a length 407. Length 407 is the length of the taper of feature 402 (i.e. it is the length over which the thickness or height of feature 402 increases/decreases). Length 407 is illustratively any length. In one embodiment, length 407 is greater than 50 nanometers. In another embodiment, length 403 is between 100 to 1,000 nm.

The illustrative cross-section in FIG. 4D shows a tapered feature that is made in part from both a portion of a supplemental layer 402 and from a portion of a recording head substrate 404. Supplemental layer 402 has a tapered surface 412, and substrate 404 has a tapered surface 414. Surfaces 412 and 414 illustratively work in cooperation with each other to form a continuous or approximately continuous surface. Embodiments of tapered features that are made at least in part from a portion of a supplemental layer, such as the embodiment shown in FIG. 4D, illustratively reduce contact stress from recording head to recording media contact as compared to a tapered feature made entirely or primarily from a substrate material.

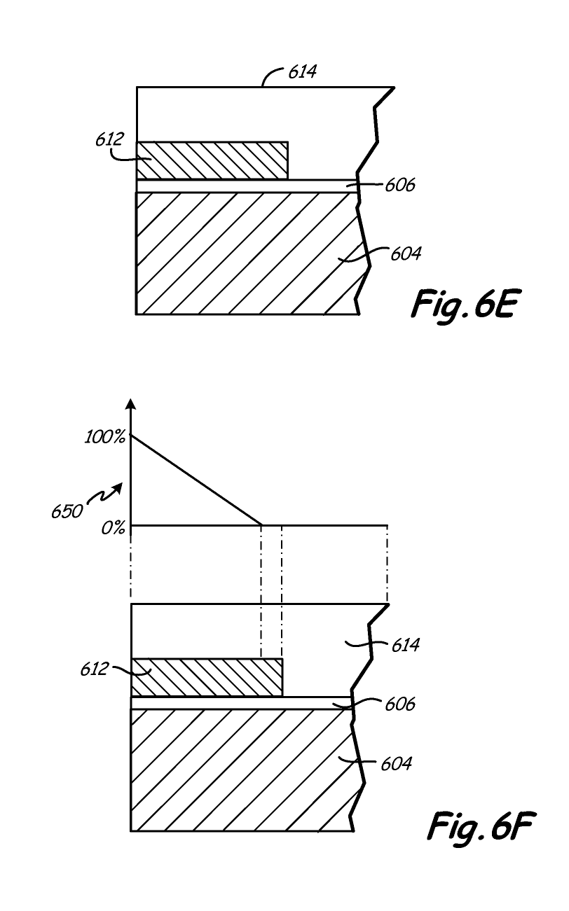

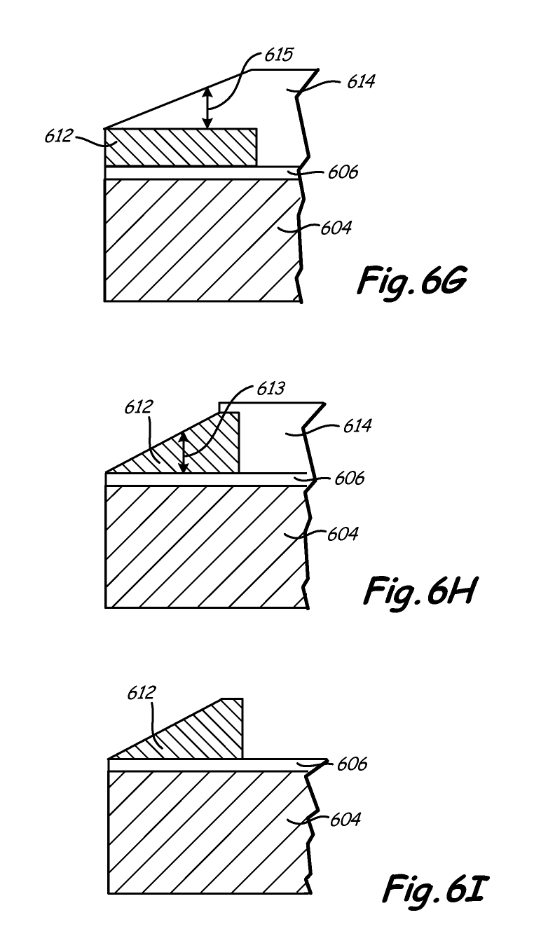

FIG. 5 is a flow diagram showing an illustrative process flow 500 that is used to make embodiments of tapered features. FIGS. 6A to 6I are illustrative cross-sections of a recording head throughout flow 500. Embodiments of the present disclosure are not however limited to any particular process flow such as flow 500 or to any specific cross-sections such as those shown in FIGS. 6A to 6I. Some of the many possible alternative variations will be discussed following the discussion of flow 500.

Process flow 500 begins at step 510. At step 510, a recording head is obtained. As was previously mentioned, embodiments of tapered features are included on any type of recording head having any variety of features. FIG. 6A shows a cross-section of a recording head that will be used for this illustration. The recording head includes a substrate layer 604 and an over coat layer 606 that is illustratively an overcoat layer such as layer 406 in FIG. 4A.

At step 520, a first layer of photoresist is applied to the recording head. The photoresist is then patterned using an exposure tool and a developer. The patterned resist defines the area or areas where the supplemental layer will be added to or cover the recording head. FIG. 6B shows an illustrative cross-section after the first layer of photoresist 608 has been developed. The area of the recording head covered by resist 608 will not have a supplemental layer. Area 610 that does not have any resist after develop will have a supplemental layer.

At step 530, the material that will form the supplemental layer is deposited on the recording head. As is shown in FIG. 6C, supplemental material 612 fills or covers both area 610 (labeled in FIG. 6B) where the supplemental layer will be formed and also the area covered by resist 608. In an embodiment, the supplemental material is illustratively a material that both reduces stress associated with recording head to recording media contact and that improves photolithographic process performance. Further details and illustrative embodiments of materials will be discussed later.

At step 540, the first resist layer is removed. An illustrative cross-section after the removal of the first resist layer is shown in FIG. 6D. FIG. 6D shows that the first resist layer 608 in FIGS. 6B and 6C is no longer present on the recording head. Additionally, supplemental material or layer 612 is only included or is predominately included in the region where the tapered feature will be formed in the final device. However, in another embodiment, supplemental material 612 is included in an extended region beyond where the tapered feature is located on the final device. For example, supplemental material 612 illustratively covers the entire air bearing surface or a half of the air bearing surface such as from the leading edge to the center of the air bearing surface. In one embodiment, supplemental material covers an area between the leading edge and any point (i.e. distance) between the leading edge and the trailing edge.

At step 550, a second layer of photoresist is applied to the recording head. An illustrative cross-section is shown in FIG. 6E. It shows a second resist layer 614 applied to the recording head. This second layer of resist will be used in patterning supplemental material or layer 612.

At step 560, the second layer of photoresist is exposed. In an embodiment, a grey scale reticle is used instead of a standard reticle. In a standard reticle, there are two basic types of regions. One region allows for light to pass through. This region can be thought of as having 100% light transmission. In the other region, an obstruction such as a layer of chrome is placed on the reticle and it prevents light from passing through. This region can be thought of as having 0% light transmission. In a grey scale reticle, there are more than two basic regions. There are one or more transition regions that partially block some of the light, while allowing the rest of the light to pass through. For example, a grey scale reticle, in addition to having areas of 100% and 0% light transmission, may also include transition regions allowing for 75%, 50%, and 25% light transmission. These transition regions allow for different regions or areas of one layer of resist to be exposed with different effective exposure energies. In an embodiment, a grey scale reticle is used that includes any number of transitional steps or increments. For example, increments of 10%, 1%, 0.1%, 0.01%, or even smaller increments are used.

FIG. 6F shows the cross-section shown in FIG. 6E along with a graphical representation 650 of the relative exposure energy along the cross-section. The horizontal axis of the graph represents the position along the cross-section and the vertical axis represents the relative exposure energy. As is shown in graph 650, the relative exposure energy illustratively decreases across supplemental layer 612 going from left to right.

At step 570, the second resist layer is developed. An illustrative cross-section after the second resist layer has been developed is shown in FIG. 6G. As can be seen in FIG. 6G, the resist thickness 615 increases going from left to right. This corresponds to the grey scale reticle used at step 560 and the differing relative exposure energies shown in FIG. 6F. The area of the cross-section furthest to the left received the highest effective exposure energy. Accordingly, that area is the most reactive or soluble in the developer solution, and the most resist is removed from that area during the develop process.

At step 580, the recording head is put into an ion milling process. The ion milling process removes or etches away material. An illustrative cross-section after the milling process is shown in FIG. 6H. As can be seen in the figure, substrate 604 and overcoat 606 were not milled at all in the process. They were protected by resist 614 and supplemental layer 612. Supplemental layer 612 however was milled. FIG. 6H shows that supplemental layer 612 has a thickness 613. Thickness 613 increases from left to right. This corresponds to the thickness of the resist previously covering layer 612 (i.e. resist thickness increased going from left to right, so the protection provided by the resist in the milling process increased going from left to right).

At step 590, the second resist layer is removed. An illustrative cross-section after the resist removal is shown in FIG. 6I. FIG. 6I shows a tapered feature 612 made from a supplemental layer that was formed upon a region of a recording head that included substrate 604 and overcoat layer 606.

Process flow 600 and the cross-sections shown in FIGS. 6A through 6I are only illustrative examples of embodiments of the present disclosure. Variations, changes, and other departures from process flow 600 and the cross-sections shown in FIGS. 6A through 6I are within the scope of the present disclosure. For example, FIG. 4C shows a tapered feature 402 in a recessed substrate 404. To form such a feature, after step 520, ion mill is used to mill away part of the substrate to form recess, then the supplemental layer is deposited. Then, the remainder of process flow 600 or an equivalent flow is followed to complete the feature. Also for example, flow 600 and cross-sections in FIGS. 6A through 6I only described forming one tapered feature. This was done merely to simplify the description. The process could easily be expanded to form multiple tapered features simultaneously. For example, the described process including the described illustrative reticles, is illustratively expanded to cover multiple tapered features.

In at least some embodiments of the present disclosure, the use of a supplemental layer improves photolithographic processing performance. In particular, embodiments of the present disclosure improve photolithographic processing performance when the substrate such as substrate 604 in FIG. 6F is a multiphase substrate.

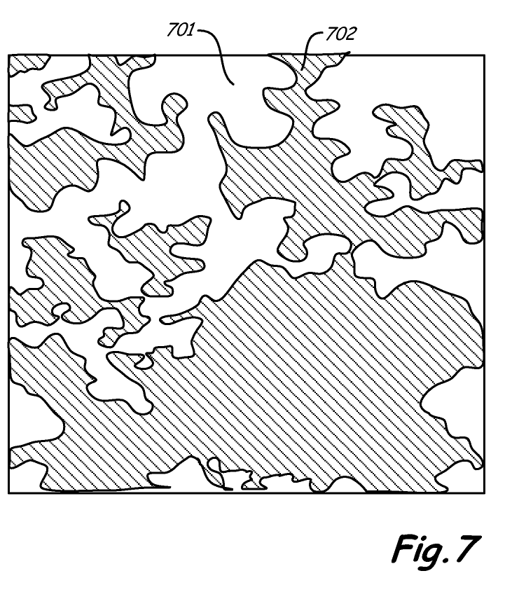

FIG. 7 is an illustrative representation of the surface of a multiphase material having two phases (i.e. it is a two-phase material) from a close-up or magnified perspective. Some areas of the surface are lighter such as the area labeled 701, and some areas are darker such as the area labeled 702. The difference in colors between areas represents that the material composition of the areas is different. For example, for illustration purposes only and not by limitation, one two-phase material is aluminum titanium carbon (AlTiC). AlTiC has a first phase that comprises Al₂O₃ and a second phase that comprises TiC. The TiC phase illustratively corresponds to area 701, and the Al₂O₃ phase illustratively corresponds to area 702. In an embodiment, TiC is approximately one-third of the AlTiC and Al₂O₃ is approximately two-thirds of the AlTiC.

In a multiphase substrate, it is common for each of the phases to have properties and characteristics that are different from the properties and characteristics of the other phases. For example, in AlTiC, the TiC phase has a higher light reflectivity property than the Al₂O₃ phase. These different properties can have a negative impact on photolithography processing performance. For example, if photoresist is applied to a two-phase substrate and it is exposed, the two different phases may reflect light differently. This results in the resist above the two-phase substrate receiving uneven effective exposure energies and consequently different develop rates. After the resist has been developed, the areas that received a higher effective exposure energy may be thinner than those areas that received a lower effective exposure energy. As a consequence, the surface of the resist after develop is uneven or rough. When this resist with a rough surface is milled, areas of the recording head with less resist receive more milling and areas with more resist receive less milling. This results in the surface of the final product (e.g. the surface of a tapered substrate corner) having a rough surface. Or in other words, the roughness of the resist surface is transferred through the milling process to the underlying substrate, making the surface of the underlying substrate rough.

In certain embodiments of the present disclosure, a supplemental layer is used with a multiphase substrate to eliminate or reduce after develop resist surface roughness. In one such embodiment, a supplemental layer is deposited on top of the substrate. The supplemental layer material and thickness is chosen such that it reduces or eliminates light reflection from the substrate. Then, resist depositing, exposing, developing, milling, and resist removal steps such as steps 530-590 in FIG. 5 are performed. As a result of the supplemental layer, there is either a reduced amount of reflected light or no reflected light from the multiphase material. Thus, the resist surface is smooth or smoother, and the underlying material being milled (which may of course be the supplemental layer as is shown in FIG. 6G) is also smooth or smoother. In one embodiment, the root mean square roughness for a milled surface is six nanometers or greater without a supplemental layer, but is reduced to less than one nanometer with a supplemental layer. This reduced surface roughness illustratively reduces damage associated with recording head to recording media contact. For example, a rough surface may be more abrasive as compared to a smoother surface. This abrasive or rough surface generates more contact stress and causes more damage to a recording medium than does a smooth or smoother surface.

In an embodiment, the supplemental layer is made from any material that reduces or eliminates the uneven reflection of light from a multiphase substrate. In certain embodiments, opaque materials are used. In one embodiment, diamond-like carbon (DLC) is used. DLC is an amorphous carbon material that includes carbon atoms bonded together through hybridized sp3 atomic orbitals. DLC is resistant to wear and has a low coefficient of friction. DLC comes in several variations. One variation is known as tetrahedral amorphous carbon (ta-C). It consists of only sp3 bonded carbon atoms. Other variations include atoms other than sp3 bonded carbon atoms such as, but not limited to, hydrogen, graphitic sp2 carbon, and metals. Embodiments of the present disclosure include a supplemental layer made from DLC in any of its variations. In such embodiments, the supplemental layer has lower contact stress with a recording medium, as compared to a substrate material such as AlTiC. This lower contact stress further reduces damage caused to a recording medium upon an impact.

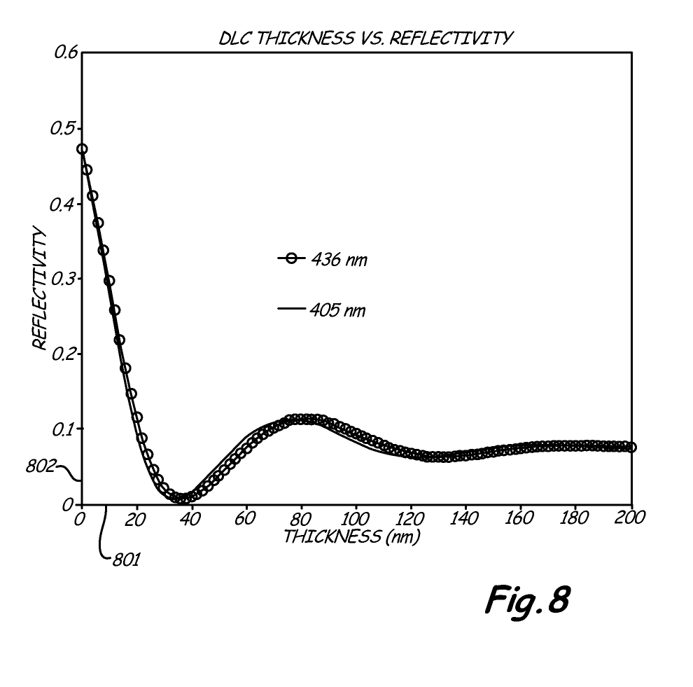

FIG. 8 is an illustrative graph that represents the amount of reflected light as a function of the thickness of the supplemental layer. In FIG. 8, a diamond-like carbon material (DLC) is used as the supplemental layer, and AlTiC is used as the substrate. The line with the circles in FIG. 8 represents the amount of reflection for light having a wavelength of 436 nanometers, and the line without circles represents the amount of reflection for light having a wavelength of 405 nanometers. The horizontal axis 801 shows the thickness of the supplemental layer in nanometers. The vertical axis 802 is a measure of reflectivity with the bottom of the vertical axis being 0 or no light reflection.

FIG. 8 shows that the reflectivity value for both wavelengths of light is approximately 0.48 or 48% when the supplemental layer has 0 thickness (i.e. there is no supplemental layer). Then, as the supplemental layer thickness is increased from 0 nanometers (nm) to approximately 34 to 36 nm, the light reflection is continually decreased. From about 34 to 36 nm of supplemental layer thickness to about 80 nm, there is a transition from decreasing to increasing. From about 80 nm to about 120 nm, the light reflection starts to decrease again. Finally, from about 120 nm onward, the light reflection is relatively stable at approximately 0.007 or 0.7%.

As can be seen in FIG. 8, light reflection from about 20 nm to 60 nm of supplemental layer thickness is much lower than it is without the supplemental layer (i.e. where the horizontal axis is 0). In fact, the light reflection is relatively close to 0 at some points (the minimum reflectivity value for both wavelengths of light is 0.006 or 0.6% which corresponds to a reduction in reflectivity by a factor of eighty as compared to when there is no supplemental layer). In such a case, as was described above, the resist surface roughness is reduced and the resulting milled feature roughness is reduced. Also, it is worth pointing out that there is a large range of values (e.g. from approximately 10 nm to 200 nm) that provides approximately half as much or less reflection than is present without the supplemental layer. Any supplemental layer within this range would reduce reflected light and would consequently reduce the resist surface roughness. Additionally, FIG. 8 shows that even a relatively small amount of supplemental layer thickness (e.g. thicknesses from greater than 0 nm to 10 nm) reduces the amount of reflection, and would consequently provide some benefit. In light of this, in one embodiment, a supplemental layer is made from diamond like carbon and has a thickness from 200 to 600 Angstroms. In another embodiment, a supplemental layer is made from diamond like carbon and has a thickness between 100 to 2,000 Angstroms. In yet another embodiment, a supplemental layer is made from diamond like carbon and has a thickness between greater than 0 Angstroms to 100 Angstroms.

Thus far, the supplemental layer has only been described with respect to embodiments that provide tapered features with reduced surface roughness. The materials and methods discussed above however are also illustratively used in other contexts. For example, recording heads commonly include features that manipulate air flow and pressure gradients. Recording heads also commonly include features to divert particulate contamination away from the recording head. The materials and methods used to provide tapered features from a supplemental layer are illustratively also used to make other features such as, but not limited to, the air flow, pressure gradient, and particle diversion features described above.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although the embodiments described herein are directed to hard disc drives, it will be appreciated by those skilled in the art that the teachings of the disclosure can be applied to other types of data storage systems, without departing from the scope and spirit of the disclosure.

What is claimed is:

1. A recording head comprising:
a substrate layer made of a first material, the substrate layer having a bearing surface side; and
a tapered feature on the bearing surface side, the tapered feature made of a second material.

2. The recording head of claim 1 wherein the first material is a multiphase material.

3. The recording head of claim 2 wherein one of the phases is Al₂O₃.

4. The recording head of claim 2 wherein one of the phases is TiC.

5. The recording head of claim 1 wherein the second material is diamond-like carbon.

6. The recording head of claim 5 wherein a thickness of the diamond-like carbon is between 200 to 600 Angstroms.

7. The recording head of claim 1 and further comprising:
an overcoat layer, the overcoat layer being located between the substrate layer and the tapered feature.

8. A recording head comprising:
a bearing surface side;
a supplemental layer on the bearing surface side; and
a tapered feature made at least in part from the supplemental layer, the tapered feature having a first side, a second side, a third side, and a fourth side, wherein a thickness of the tapered feature increases from the first side to the third side, and wherein the thickness of the tapered feature increases from the second side to the fourth side.

9. The recording head of claim 8 wherein the bearing surface side has a leading edge, the leading edge having two corner regions, and wherein the tapered feature is located in one of the two corner regions.

10. The recording head of claim 9 wherein a second tapered feature is located in the other corner region.

11. The recording head of claim 8 wherein the bearing surface side has a trailing edge, the trailing edge having two corner regions, and wherein the tapered feature is located in one of the two corner regions.

12. The recording head of claim 11 wherein a second tapered feature is located in the other corner region.

13. The recording head of claim 8 wherein the bearing surface has four corner regions and the tapered feature is located in a region other than the four corner regions.

14. The recording head of claim 8 and further comprising a second tapered feature, a third tapered feature, and a fourth tapered feature.

15. A recording head comprising:
a bearing surface having a leading edge and a trailing edge;
a multiphase substrate that forms at least a portion of the bearing surface;
a diamond-like carbon layer on the bearing surface, the diamond-like carbon layer extending from the leading edge to a point between the leading edge and the trailing edge, wherein a thickness of the diamond-like carbon layer increases from the leading edge to the point.

16. The recording head of claim 15 wherein one of the phases of the multiphase substrate has a first reflectivity and a second one of the phases of the multiphase substrate has a second reflectivity.

17. The recording head of claim 15 wherein the diamond like carbon layer comprises atoms of carbon bonded together through sp3 hybridized atomic orbitals.

18. The recording head of claim 15 wherein the diamond-like carbon layer has a surface roughness root mean square error that is less than one nanometer.

19. The recording head of claim 15 and further comprising an overcoat layer on at least a portion of the bearing surface.

20. The recording head of claim 15 wherein the trailing edge comprises a read/write component.
